(19) United States
(12) Patent Application Publication
(10) Pub. No.: US 2022/0034153 A1
(43) Pub. Date: Feb. 3, 2022

(54) DOOR SKINS AND METHOD OF MAKING

(71) Applicant: Steves and Sons, Inc., San Antonio, TX (US)

(72) Inventors: Gregory James WYSOCK, Huntley, IL (US); John F. AMBRUZ, West Harrison, NY (US); Sam Bell STEVES, II, San Antonio, TX (US); Edward STEVES, San Antonio, TX (US)

(21) Appl. No.: 17/388,303

(22) Filed: Jul. 29, 2021

Related U.S. Application Data
(60) Provisional application No. 63/058,105, filed on Jul. 29, 2020.

(51) Int. Cl. E06B 3/70; B32B 21/08; B32B 21/02; B27N 7/00

(52) U.S. Cl. CPC E06B 3/7001; B32B 21/08; B32B 21/02; B32B 2250/02; E06B 2003/7049; B32B 2419/00; B27N 7/005

(57) ABSTRACT

The present disclosure is directed to molded door skins and methods of making. Methods include providing an at least partially consolidated flat wood composite blank. Methods further include positioning a stretchable film on an outer surface of the blank, and pressing the blank and the stretchable film together in a heated press to form the molded door skin. The molded door skin has a first surface and a second surface recessed relative to the first surface by a predetermined distance. A third planar portion extends between first and second planar portions at an angle in a range of 100 degrees and 120 degrees. Cracks or voids formed in the outer surface of the blank during the pressing are filled with the stretchable film such that an outer surface of the molded door skin is substantially or entirely crack and void free.

### CROSS-REFERENCE TO RELATED APPLICATIONS

This application claims the benefit of U.S. Application No. 63/058,105, filed Jul. 29, 2020, which is incorporated herein by reference thereto.

### FIELD

The present disclosure relates to door skins and methods of making door skins.

### BACKGROUND

Shaker-style doors are one of the more popular door styles on the market. A shaker-style door includes a square profile shape or sticking. That is, the transition between the rails, stiles, and panels of the door forms right angles.

Traditional wood shaker-style doors are formed using separate rails and stiles assembled about one or more panels via mortise-and-tenon joints and wooden pegs. The assembly of two rails and two stiles around a single panel (though more rails or panels are possible) is referred to herein as a five-piece construction technique. The assembled rails, stiles, and panels reduce warping and provide superior door strength. Accordingly, traditional shaker-style doors set high standards of construction and design. Nevertheless, the mortise-and-tenon joints and or five-piece construction technique increases door costs and complicates manufacturability of the doors.

Molded doors are an alternative to mortise-and-tenon joints and or five-piece construction techniques. Molded door construction techniques involve the formation of molded door skins, typically two, that are fixed to the front and back of a frame. Molded doors can be hollow, or can include a core within a space defined by the door skins and the frame.

Molded door skins can be formed from a thick, non-consolidated, flexible mats of wood fiber and resin material. A press presses and molds the non-consolidated wood fiber and resin mat of material to form a comparably thin, dense molded door skin. Because the mat is flexible and non-consolidated, it can be pressed into a molded door skin having defined features, including profile shapes similar to the traditional door styles. This molding technique improves manufacturability and lowers costs relative to traditional mortise-and-tenon and or five-piece construction techniques. Nevertheless, the non-consolidated, flexible mats of wood fiber and resin are difficult to handle and accordingly require significant investment in machinery (e.g., multi-opening presses, dies, etc.) to convey and press the mats into the molded skins.

Another technique for manufacturing molded door skins uses a semi-solid consolidated and or low density consolidated flat wood composite blank instead of the non-consolidated wood fiber & resin flexible the flexible mat. Heat and/or moisture is applied to the blank prior to or concurrently with pressing the blank during this process.

Nevertheless, known techniques for manufacturing molded door skins from semi-consolidated and or low density consolidated flat wood composite blanks are unsuitable for forming sharply defined features, including profile shapes similar to the traditional shaker-style, due to the formation of cracks and voids in the outer surface of the molded door skin during the molding processes.

### BRIEF SUMMARY

An objective of the disclosure then is to form a molded-door skin having a profile shape closely approximating the shaker-style profile using a manufacturing technique that simplifies the manufacturing process, that can be performed economically, and that produces a molded-door skin with an outer surface that is substantially free of cracks and voids.

This objective is met with the disclosed molded door skins in some embodiments. In some embodiments, a molded door skin includes a first planar portion defining a first surface. The molded door skin also includes a second planar portion extending parallel to the first planar portion. The second planar portion defines a second surface recessed relative to the first surface by a predetermined distance. The molded door skin further includes a third planar portion extending between the first and second planar portions. The third planar portion extends from the second planar portion at an angle in a range of 100 degrees and 120 degrees. The first, second, and third planar portions collectively define an outer surface of the molded door skin that is substantially or entirely crack and void free.

This objective is also met with other molded door skins disclosed herein. In some embodiments, a molded door skin includes a first planar portion defining a first surface. The molded door skin also includes a second planar portion extending parallel to the first planar portion. The second planar portion defines a second surface recessed relative to the first surface by a predetermined distance. The molded door skin further includes a third planar portion extending between the first and second planar portions. The third planar portion extending from the second planar portion at an angle in a range of 100 degrees and 120 degrees. The first, second, and third planar portions collectively define an outer surface of the molded door skin that is infused with a stretchable film such that the outer surface is substantially or entirely crack and void free in some embodiments.

This objective is also met with a method of forming a molded door skin disclosed herein in some embodiments. In some embodiments, a method of forming a molded door skin includes providing a blank. The blank can be an at least partially consolidated flat wood composite. The method also includes pressing the blank in a heated press at a predetermined pressure for a predetermined amount of time to form the molded door skin. The molded door skin can have a first planar portion defining a first surface. The molded door skin can also have a second planar portion extending parallel to the first planar portion. The second planar portion can define a second surface recessed relative to the first surface by a predetermined distance. The molded door skin can have a third planar portion extending between the first and second planar portions. The third planar portion can extend from the second planar portion at an angle in a range of 100 degrees and 120 degrees. The first, second, and third planar portions collectively define an outer surface of the molded door skin that is substantially or entirely crack and void free in some embodiments.

This objective is also met with other methods of forming the molded door skin disclosed herein. In some embodiments, a method of forming the molded door skin includes providing a blank. The blank can be at least partially consolidated flat wood composite. The method can also include positioning a stretchable film on an outer surface of the blank and pressing the blank and the stretchable film together in a heated press to form the molded door skin. The molded door skin can have a first planar portion defining a first surface. The molded door skin can have a second planar portion extending parallel to the first planar portion. The second planar portion can define a second surface recessed relative to the first surface by a predetermined distance. The molded door skin can also have a third planar portion extending between the first and second planar portions. The third planar portion extending from the second planar portion at an angle in a range of 100 degrees and 120 degrees. In some embodiments, cracks or voids formed in the outer surface of the blank during the pressing are filled with the stretchable film such that an outer surface of the molded door skin is substantially or entirely crack and void free.

### BRIEF DESCRIPTION OF THE DRAWINGS

The accompanying figures, which are incorporated herein, form part of the specification and illustrate aspects of the present disclosure. Together with the description, the figures further serve to explain the principles of and to enable a person skilled in the relevant arts to make and use the invention.

FIG. 1 depicts an exemplary molded door skin formed in accordance with aspects of disclosure.

FIG. 2 depicts a cross-sectional view of the molded door skin depicted in FIG. 1 taken along line 2-2.

FIG. 3 depicts another exemplary molded door skin formed in accordance with aspects of the disclosure.

FIG. 4 depicts a cross-sectional view of the molded door skin depicted in FIG. 3 taken along line 4-4.

FIG. 5 depicts an exemplary two panel molded door skin in accordance with aspects of the disclosure.

FIG. 6 depicts an exemplary three panel molded door skin in accordance with aspects of the disclosure.

FIG. 7 depicts another exemplary three panel molded door skin in accordance with aspects of the disclosure.

FIG. 8 depicts an exemplary five panel molded door skin in accordance with aspects of the disclosure.

FIG. 9 depicts a method of forming a molded door skin according to aspects of the disclosure.

FIG. 10A depicts a cross-sectional view of a blank arranged in a press having an exemplary die arrangement according to aspects of the disclosure.

FIG. 10B depicts a cross-sectional view of a blank arranged in a press having another exemplary die arrangement according to aspects of the disclosure.

FIG. 11 depicts another method of forming a molded door skin according to aspects of the disclosure.

FIG. 12A depicts a cross-sectional view of a blank and a stretchable film arranged in the press having the die arrangement of FIG. 10A.

FIG. 12B depicts a cross-sectional view of a blank and a stretchable film arranged in the press having the die arrangement of FIG. 10B.

### DETAILED DESCRIPTION

Embodiments of the present invention will now be described in detail with reference to embodiments thereof as illustrated in the accompanying drawings. References to “one aspect,” “an aspect,” “an example aspect,” “some aspects,” “some embodiments,” “an embodiment,” “exemplary,” etc., indicate that the aspect described may include a particular feature, structure, or characteristic, but every aspect may not necessarily include the particular feature, structure, or characteristic. Further, when a particular feature, structure, or characteristic is described in connection with an aspect, it is submitted that it is within the knowledge of one skilled in the art to affect such feature, structure, or characteristic in connection with other aspects whether or not explicitly described.

Unless clearly indicated to the contrary (e.g., either x or y, but not both x and y) or readily contextually apparent, the term “or” as used herein is inclusive (i.e., x or y includes just x, just y, and x and y). Moreover, such phrases are not necessarily referring to the same aspect.

The term “invention” or “present invention” as used herein is a non-limiting term and is not intended to refer to any single embodiment of the particular invention but encompasses all possible embodiments as described in the application.

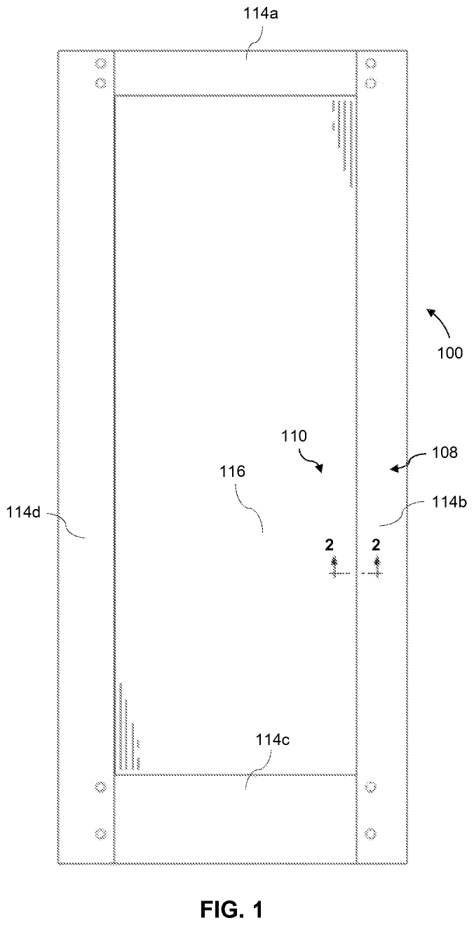

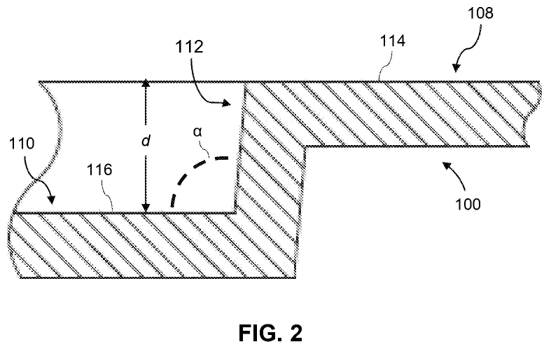

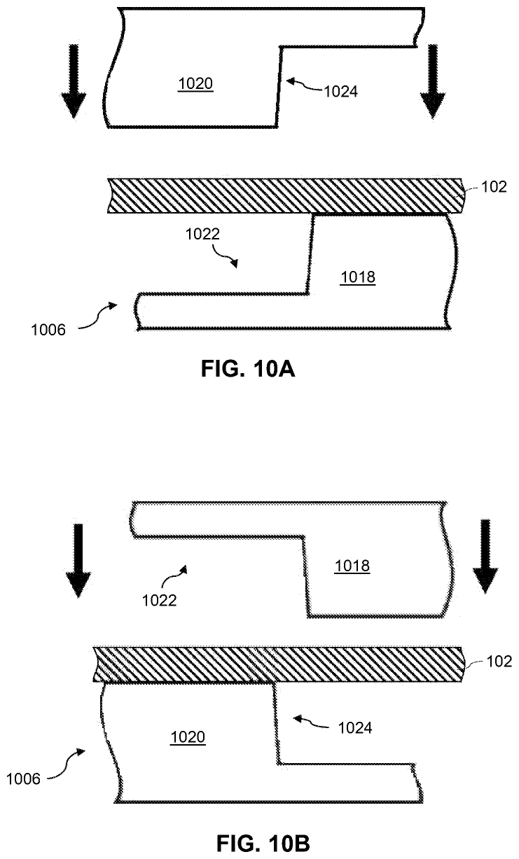

FIGS. 1 and 2 respectively show a top-down view of a molded door skin 100 and a cross-sectional view of the molded door skin 100 along line 2-2 in accordance with aspects of the disclosure. The molded door skin 100 can be formed from a blank 102 (for example, as shown in FIGS. 10A and 10B, and described below) to have at least a first planar portion 108, a second planar portion 110, and a third portion 112 (best seen in FIG. 2). The first planar portion 108 can define a first surface 114. The second planar portion 110 can extend parallel to the first planar portion 108. The second planar portion 110 can define a second surface 116 recessed relative to the first surface 114 by a distance d. The third portion 112 can extend between the first and second planar portions 108, 110. In some embodiments, third portion 112 is planar as shown in FIG. 2. The third portion 112 can extend from the second planar portion 110 at an angle α. In some embodiments, the angle α can be in a range of 100 degrees and 120 degrees and thus the profile shape of the molded door skin 100 can closely approximate a traditional shaker-style profile. In other embodiments, the angle α can be in a range of 90 degrees and 100 degrees and thus the profile shape of the molded door skin 100 can closely approximate a traditional shaker-style profile. As discussed above, the shaker-style profile is a square profile shape or sticking, i.e., where the transition from the door rails and stiles to the interior panel(s) forms a substantially right angle. Thus, “closely approximating a shaker-style profile” as used herein can correspond to an angle α in a range of 90 degrees to 120 degrees.

In other embodiments not shown, third portion 112 is not planar.

In some embodiments, the first, second, and third portions 108, 110, 112 can collectively define an outer surface of the molded door skin that is substantially or entirely crack and void free. The outer surface can be an exposed surface of the molded door skin 100 that is visually observable. The term “substantially crack and void free,” as used herein, means largely but not entirely free of cracks and voids that would be readily apparent to an ordinary human observer with the naked eye. Cracks and voids (e.g., micro or nano sized) that would not be readily apparent to an ordinary human observer with the naked eye can be present at the outer surface of the molded door skin and the molded door skin can nevertheless be substantially or entirely crack and void free, as defined in this disclosure.

The second surface 116 of the second planar portion 110 can be recessed relative to the first surface 114 of the first planar portion 108 by the distance d. In some embodiments, the distance d can be in a range of 4 mm to 12 mm, for example, in the range of 6 mm to 9 mm. In other embodiments, the distance d is greater than 9 mm.

In some embodiments, the caliper (or thickness) of the first, second, and third portions 108, 110, and 112 is in the range of 2.4 mm to 50.8 mm, for example, about 3.17 mm.

In some embodiments, the ratio of the distance d to the caliper of the first, second, or third portions 108, 110, and 112 is in the range of 0.079:1 to 5:1, for example, in the range of 1.7:1 to 3.0:1 and, for example, 1.89:1 to 2.84:1.

In some embodiments, the third portion 112 can abut each of the first and second planar portions 108, 110.

As shown in FIG. 1, the molded door skin 100 can include at least one second surface 116 that defines a panel of the molded door skin 100. The molded door skin 100 can include four first surfaces 114a, 114b, 114c, and 114d. Two of the first surfaces 114a, 114c can extend predominantly in a horizontal direction and can define rails of the molded door skin 100. Two of the first surfaces 114b, 114d can extend predominantly in a vertical direction and can define stiles of the molded door skin 100. As such, the first surfaces 114a, 114b, 114c, and 114d surround the at least one second surface 116 defining a panel.

As discussed above, the molded door skin 100 can be formed from a blank 102. The molded door skin 100 may be formed from the blank 102 via a post-forming process, such as the methods 900 and 1100 discussed in detail below. The blank 102 can be an at least partially consolidated flat wood composite. At least partially consolidated wood composite can mean that the blank 102 is denser and thinner than a comparable composite mat that has not undergone consolidation, as would be readily apparent to a skilled artisan. The blank 102 can include resin that is partially, but not fully cured. Because the blank 102 can be partially consolidated and can include resin that is partially but not fully cured, the blank 102 can be sufficiently solid to maintain its shape yet sufficiently pliable (when subject to heat and/or pressure, for example) to facilitate further processing into the molded door skin 100. In some embodiments, the blank 102 can be sufficiently solid such that the blank 102 is “handlable,” or readily movable or storable without altering the shape of the blank 102. The blank 102 can be moved manually without altering the shape of the blank 102. In addition, the blank 102 can be thicker in caliper and lower in density than a caliper and density of the molded door skin 100.

The blank 102 can include wood and resin. In some embodiments, the wood can include one or more of particleboard, medium density fiberboard, hard board, flake board, wood flower, wood composites, etc.

In some embodiments, the wood can be provide as fibers.

In some embodiments, the blank 102 can be comprised other materials, either alternatively or additionally with the wood. These other materials can include plastics, metals, soy, bamboo, hemp, engineered materials, etc.

In some embodiments, the resin can be a thermal setting resin that can maintain the wood fibers in a solid state.

The blank 102 can be a rectangular cuboid shape. That is, the blank 102 can include six substantially planar rectangular outer surfaces and each pair of adjacent planar rectangular outer surfaces can meet at substantially right angles. The blank 102 can include major top and bottom planar rectangular outer surfaces. The major top and bottom rectangular outer surfaces can be the two surfaces of the blank 102 having the greatest surface area. The major top and bottom rectangular outer surfaces can be substantially planar, and thus the blank 102 can be flat. That is, the major top and bottom rectangular outer surfaces can be substantially flush without panels, moldings, profile shapes, etc. The flat blank 102 can support stacking and storing of a plurality of blanks 102 prior to processing into the molded door skin 100.

In some embodiments, the blank 102 can be curved. For example, one or more of the major top and bottom surfaces of the blank 102 can have convex or concave shapes.

In some embodiments, the blank 102 can include concave major top and bottom surfaces.

In some embodiments, the blank 102 can include convex major top and bottom surfaces.

In some embodiments, the blank 102 can include a convex major top surface and a concave major bottom surface.

In some embodiments, the blank 102 can include a concave major top surface and a convex major bottom surface.

The blank 102 can be contrasted with the comparably thick, flexible, and amorphous mats of wood used in alternate molding processes. The blank 102 can be thinner in caliper and thicker in density than mats of wood used in alternate molding processes. The mats of wood used in such alternate molding processes can be produced from wet or dry fibers. These mats of wood are comparably expensive inputs for molded door skin manufacturing processes due to the complexity of the manufacturing the molded door skins from the mats. Further, these mats are less suited for manufacturing techniques that can include manual manipulation, since the flexible mats are difficult to move or store without altering the shape of the mats. Thus by utilizing the blank 102, costs associated with the formation of the molded door skin 100 can be reduced as can the complexity of the manufacturing process.

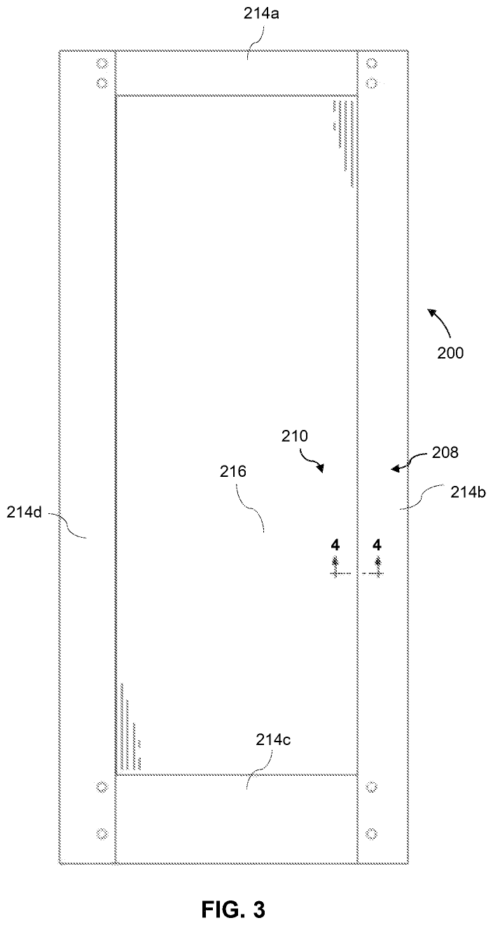

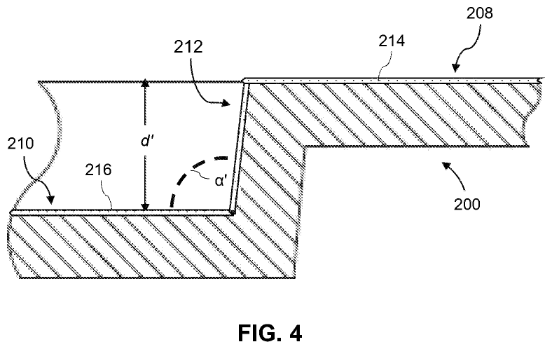

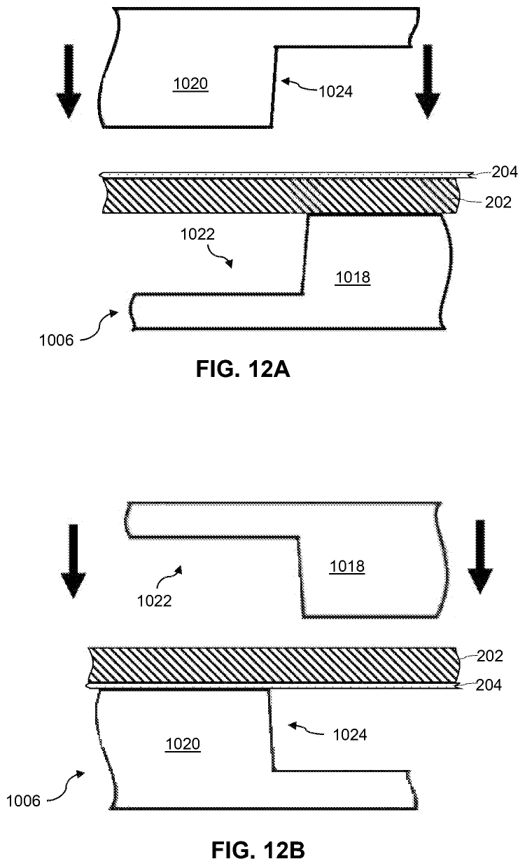

FIGS. 3 and 4 respectively show a top-down view of another molded door skin 200 and a cross-sectional view of the molded door skin 200 along line 4-4 in accordance with aspects of the disclosure. The molded door skin 200 can be formed from a blank 202 (as shown in FIGS. 12A and 12B). The blank 202 can include any or all of the features of the blank 102, as discussed above. The molded door skin 200 can be formed from the blank 202 to have at least a first planar portion 208, a second planar portion 210, and a third portion 212. The first planar portion 208 can define a first surface 214. The second planar portion 210 can extend parallel to the first planar portion 208. The second planar portion 210 can define a second surface 216 recessed relative to the first surface 214 by a distance d′. The third portion 212 can extend between the first and second planar portions 208, 210. In some embodiments, the third portion 212 is planar as shown in FIG. 2.

In other embodiments not shown, third portion 112 is not planar.

The third portion 212 can extend from the second planar portion 210 at an angle α′. In some embodiments, the angle α′ can be in a range of 100 degrees and 120 degrees and thus the profile shape of the molded door skin 200 can closely approximate a traditional shaker-style profile. In other embodiments, the angle α can be in a range of 90 degrees and 100 degrees and thus the profile shape of the molded door skin 200 can closely approximate a traditional shaker-style profile.

Cracks or voids formed in the outer surface of the blank 202 during the formation of the molded door skin can be infused with a stretchable film 204 (as shown in FIGS. 12A and 12B, and described below) such that an outer surface of the molded door skin 200 is substantially or entirely crack and void free. The first, second, and third portions 208, 210, 212 infused with the stretchable film 204 can collectively define the outer surface of the molded door skin. The outer surface can be an exposed surface of the molded door skin 200 that is visually observable.

In some embodiments, the distance d′ can be in a range of 4 mm to 12 mm, for example, between 6 mm and 9 mm. In other embodiments, the distance d′ is greater than 9 mm.

In some embodiments, the caliper (or thickness) of the first, second, and third portions 208, 210, and 212 is in the range of 2.4 mm to 50.8 mm, for example, about 3.17 mm.

In some embodiments, the ratio of the distance d′ to the caliper of the first, second, or third portions 208, 210, and 212 is in the range of 0.079:1 to 5:1, for example, in the range of 1.7:1 to 3.0:1 and, for example, 1.89:1 to 2.84:1.

In some embodiments, the third planar portion 212 can abut each of the first and second planar portions 208, 210.

The stretchable film 204 can be configured to cover or fill cracks or voids in the molded door skin 200 that are formed during the formation of the molded door skin 200 to provide a substantially or entirely crack and void free surface. The stretchable film 204 can be infused into the blank 202 during formation of the molded door skin 200. Accordingly, the stretchable film 204 can improve or enhance the consistency of the surface appearance of the molded door skin 200. This is in contrast to typical decorative overlays, such as wood veneer, that merely mask the surface appearance of the underlying door skin with an alternative decorative layer without filling cracks or voids in the outer surface. Wood veneer provides a wood grain appearance different than that of the underlying molded door skin. Nevertheless, stretchable film 204 is comparatively better suited for subsequent painting.

In some embodiments, the stretchable film 204 can be phenolic impregnated crepe paper. Alternatively, the stretchable film 204 can be melamine or urea impregnated crepe paper. Before molded door skin 204 is formed, the stretchable film 204 can include dimples that facilitate stretching. Before molded door skin 204 is formed, the stretchable film 204 can have an expansion factor sufficient to allow formation of the desired molded door skin 200 profile shape without splitting or tearing the crepe paper. The stretchable film 204 can form an outer surface of the molded door skin 200.

In some embodiments, the stretchable film 204 disclosed herein includes no wood grain or decorative patterns.

In some embodiments, the stretchable film 204 can be pigmented. The pigmentation can be white. The pigmented stretchable film can be a primer that enables better absorption or adherence of paint and can reduce the total amount of paint needed. Thus, the molded door skin 200 in accordance with aspects of the disclosure can more readily accept paint than molded door skins utilizing wood veneer.

As shown in FIG. 3, the molded door skin 200 can include one second surface 216 that defines a panel of the molded door skin 200. The molded door skin 200 can include four first surfaces 214a, 214b, 214c, and 214d. Two of the first surfaces 214a, 214c can extend predominantly in a horizontal direction and can define rails of the molded door skin 200. Two of the first surfaces 214b, 214d can extend predominantly in a vertical direction and can define stiles of the molded door skin 200.

Although the molded door skins 100, 200 described above include one panel, aspects of the disclosure are not limited to single panel door skins. The above-described molded door skins 100, 200 can alternatively be multiple panel door skins in accordance with any of the following embodiments.

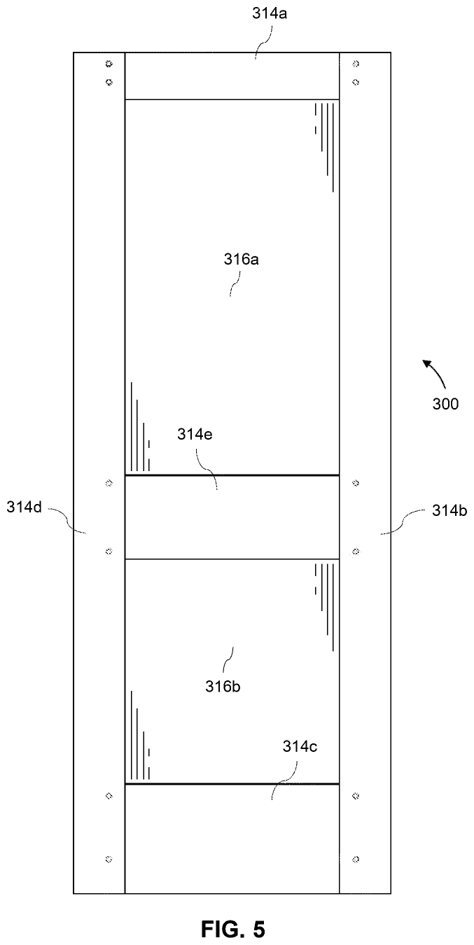

For example, FIGS. 5-8 illustrate multiple panel door skins according to some embodiments. Like-reference numerals correspond to like-reference numerals and each of the following door skins can have profile shapes in accordance with any and all of the features of molded door skins 100, 200.

FIG. 5 shows a top-down view of a molded door skin 300 in accordance with aspects of the disclosure. The molded door skin 300 can include two second surfaces 316a, 316b that each define a panel of the molded door skin 300. That is, the molded door skin 300 can be two paneled. The molded door skin 300 can include five first surfaces 314a, 314b, 314c, 314d, 314e. Three of the first surfaces 314a, 314c, 314e can extend predominantly in a horizontal direction and can define rails of the molded door skin 300. Two of the first surfaces 314b, 314d can extend predominantly in a vertical direction and can define stiles of the molded door skin 300.

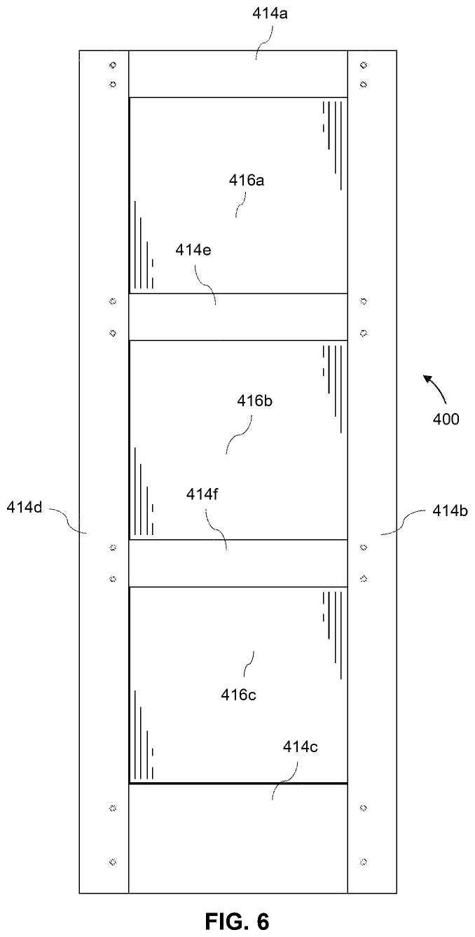

FIG. 6 shows a top-down view of a molded door skin 400 in accordance with aspects of the disclosure. The molded door skin 400 can include three second surfaces 416a, 416b, 416c that each define a panel of the molded door skin 400. That is, the molded door skin 400 can be three paneled. The molded door skin 400 can include six first surfaces 414a, 414b, 414c, 414d, 414e, 414f. Four of the first surfaces 414a, 414c, 414e, 414f can extend predominantly in a horizontal direction and can define rails of the molded door skin 400. Two of the first surfaces 414b, 414d can extend predominantly in a vertical direction and can define stiles of the molded door skin 400.

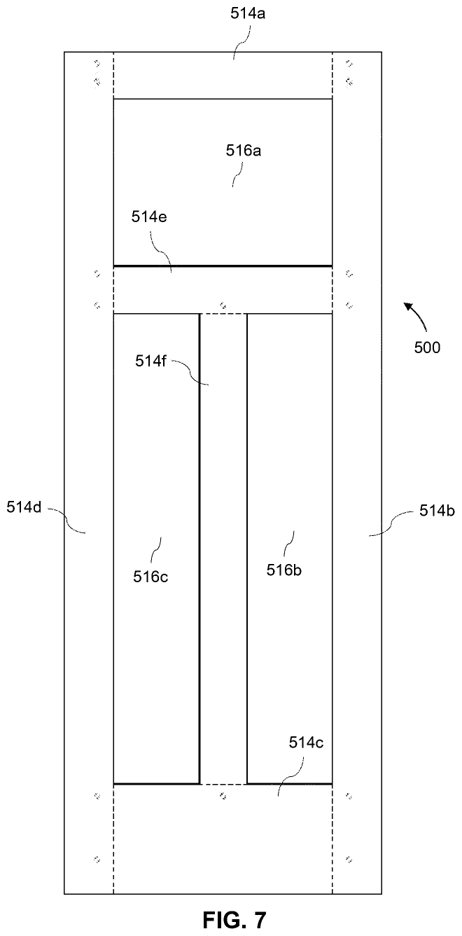

FIG. 7 shows a top-down view of a molded door skin 500 in accordance with aspects of the disclosure. The molded door skin 500 can include three second surfaces 516a, 516b, 516c that each define a panel of the molded door skin 500. That is, the molded door skin 500 can be three paneled. The molded door skin 500 can include six first surfaces 514a, 514b, 514c, 514d, 514e, 514f. Three of the first surfaces 514a, 514c, 514e can extend predominantly in a horizontal direction and can define rails of the molded door skin 500. Three of the first surfaces 514b, 514d, 514f can extend predominantly in a vertical direction and can define stiles of the molded door skin 500.

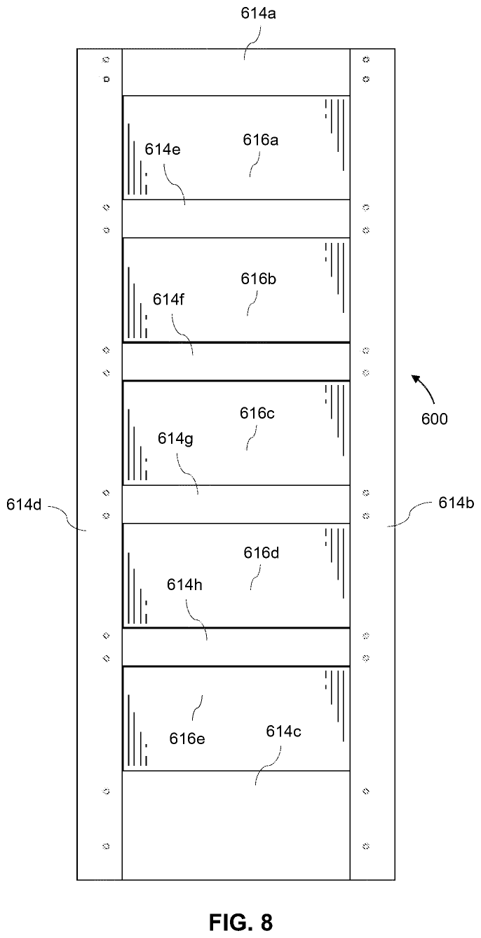

FIG. 8 shows a top-down view of a molded door skin 600 in accordance with aspects of the disclosure. The molded door skin 600 can include five second surfaces 616a, 616b, 616c, 616d, 616e that each define a panel of the molded door skin 600. That is, the molded door skin 600 can be five paneled. The molded door skin 600 can include eight first surfaces 614a, 614b, 614c, 614d, 614e, 614f, 614g, 614h. Six of the first surfaces 614a, 614c, 614e, 614f, 614g, 614h can extend predominantly in a horizontal direction and can define rails of the molded door skin 600. Two of the first surfaces 614b, 614d can extend predominantly in a vertical direction and can define stiles of the molded door skin 600.

### Methods of Forming Molded Door Skins

In some embodiments, the molded door skins 100-600 closely approximating the shaker-style profile can be made using a post-form process. The post-form process can include subjecting the blank to heat or moisture prior to or concurrently with pressing the blank to form the molded door skin. Two exemplary post-form process 900, 1100 are described below.

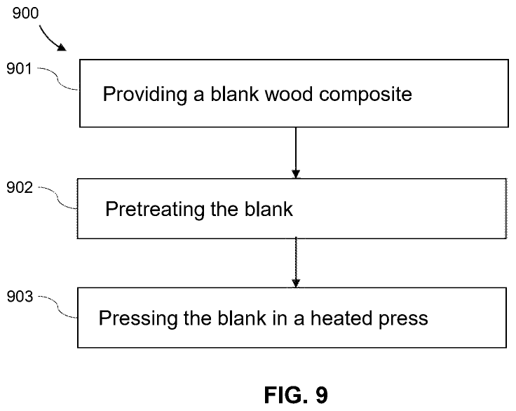

FIG. 9 depicts a method 900 of forming a molded door skin in accordance with aspects of the disclosure. The method 900 can, for example, form the molded door skin 100. The method can include, at step 901, providing the blank 102. The method may optionally include, at step 902, pretreating the blank. The method can include, at step 903, pressing the blank 102 in a heated press 1026. FIGS. 10A and 10B depict embodiments of pressing the blank 102 in the heated press 1006 at step 903 in accordance with aspects of the disclosure.

The pressure that the press 1006 applies to the blank 102 at step 903 can be a predetermined pressure. The predetermined pressure can be applied to the blank 102 for a predetermined period of time during which the blank 102 is heated and pressed to form the molded door skin 100. According to aspects of the disclosure, the pressure applied to the blank 102 can vary cyclically between predetermined upper and lower pressures. The closing and opening cycle speeds of the press 1006 can be variable. According to aspects of the disclosure, pressing at step 903 can include applying moisture or conditioner to the blank 102. Upon completion of the pressing, the molded door skin 100 can be removed from the opening of the press 1006 face down or face up. The molded door skin 100 can be removed manually.

In some embodiments, the predetermined pressure applied at step 903 can be between 35 kg/cm² to 65 kg/cm², for example 55 kg/cm².

In some embodiments, step 903 can include heating the molded door skin to 133 degrees C. to 247 degrees C., for example 190 degrees C.

In some embodiments, the cycle time (i.e., the time for the pressure applied to the blank 102 to vary between predetermined upper and lower pressures) employed at step 903 can be between 2.5 minutes and 4.6 minutes, for example, 3.5 minutes.

In some embodiments, the molded door skin 100 can have a moisture content between 21% and 39%, for example 30%, before pressure and/or heat is applied to the blank 102.

In some embodiments, the heated press 1006 that presses the blank 102 to form the molded door skin 100 at step 903 can include at least one opening for receiving the blank 102 or removing the resulting molded door skin 200. The press 1006 can apply heat and pressure in quantities sufficient to allow the fiber and resin of the blank 102 to fully consolidate and cure to form the molded door skin 100.

In some embodiments, the heated press 1006 can be a single-opening press (i.e., can only include one opening) for receiving or removing the blank 102 or the molded door skin 100. The single-opening press 1006 can be readily operated manually without the need for sophisticated loading systems (e.g., a preloader).

In some embodiments, the heated press 1006 can be a multi-opening press, which can facilitate higher molded door skin outputs compared to a single-opening press.

In some embodiments, the press 1006 can include a carrier system for conveying the blank 102. The carrier system can be heated, which can prevent deformation of the carrier system during the subsequent heating at step 903 and can reduce the time required to heat the blank 102. The carrier system can include a steel belt or woven wire mesh carrier.

As discussed above, the method 900 can optionally include pretreating the blank 102 at step 902. Pretreating the blank 102 can occur prior to pressing the blank 102 in the heated press 1006. In some embodiments, the pre-treatment can include a pre-press, and the blank 102 can be pressed in the pre-press before the pressing at the heated press 1006. Pre-pressing the blank 102 can decrease the resistance of the blank 102 in the heated press 1006 at step 903, to reduce the time required for the pressing at step 903 or to improve the quality of the resultant molded door skin 100.

In some embodiments, the pre-treatment can include a pre-heating step. For example, the blank can be pre-heated using a pre-heater, such as a high frequency heated tunnel.

The heated press 1006 can include a first die 1018 and a second die 1020. The first and second dies 1018, 1020 can be heated by heaters. In some embodiments, the heaters can heat via electric current. In some embodiments, the heaters can heat via a working fluid (e.g., water, coolant, etc.). Accordingly, the first and second dies 1018, 1020 can apply the heat to the blank 102 at step 903. As shown in the cross-sectional view of FIGS. 10A and 10B, the first and second dies 1018, 1020 can have complimentary opposing shapes that form the profile shape of the molded door skin 100 in accordance with aspects of the disclosure. The press 1006 can include first and second platens for respectively mounting the first and second dies 1018, 1020.

The first die 1018 can have a cavity 1022. Thus, the first die 1018 be a cavity mold. The second die 220 can have a protrusion 1020 and can be a core mold.

In the embodiment shown in FIG. 10A, the second die 1020 can be disposed at the top of the press 1006 and the first die 1018 can be disposed at the bottom of the press 1006. As indicated by the directional arrows in FIG. 10A, the second die 1020 can move towards the first die 1018 and the protrusion 1020 can press the blank 102 and mold the blank 102 into the cavity to form the panel(s) of the molded door skin 100. In some embodiments, the first and second dies 1018, 1020 can each move towards each other during the pressing of the blank 102. The top surface of the blank 102 of FIG. 10A, which opposes and is pressed by the second die 1020, can be formed into the first, second, and third portions 108, 110, 112 that collectively define the outer (i.e., visually observable) surface of the molded door skin 100.

In the embodiment shown in FIG. 10B, the first die 1018 can be disposed at the top of the press 1006 and the second die 1020 can be disposed at the bottom of the press 1006. As indicated by directional arrows in FIG. 10B, the first die 1018 can move towards the second die 1020. The blank 102 can be formed into the molded door skin 100 around the protrusion 1020 and into the cavity 1022. In some embodiments, the first and second dies 1018, 1020 can move towards each other during the pressing of the blank 102. The bottom surface of the blank 102 of FIG. 10B, which opposes and is pressed by the second die 1020, can be formed into the first, second, and third portions 108, 110, 112 that collectively define the outer (i.e., visually observable) surface of the molded door skin 100. Disposing the second die 1020 (i.e., the cavity mold) that forms the outer surface of the molded door skin 100 at the bottom of the press 106 can reduce strain on the outer surface of the molded door skin 100 to facilitate the formation of the profile shape the closely approximates the shaker style.

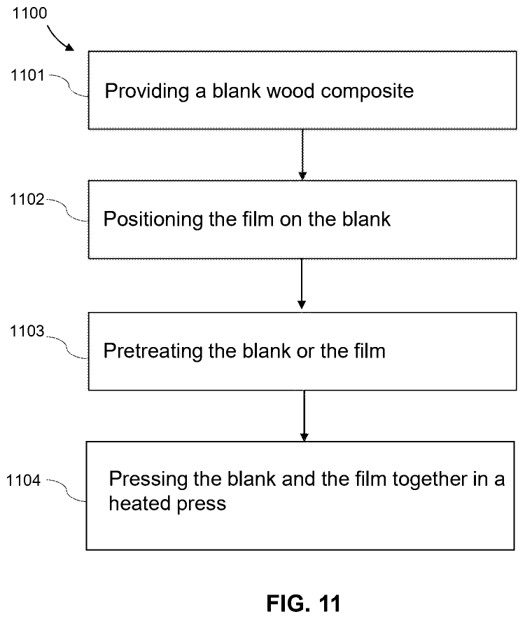

In some embodiments, the molded door skin can be made using a stretchable film 204. For example, FIG. 11 depicts a method 1100 of forming a molded door skin in accordance with aspects of the disclosure. The method 1100 can, for example, form the molded door skin 200. The method 1100 can include, at step 1101, providing the blank 202. The method 1100 can further include, at step 1102, positioning the stretchable film 204 on an outer surface of the blank 202. The method 1100 can optionally include, at step 1103, pretreating the blank 202 or the stretchable film 204. At step 1104, the method 1100 can include pressing the blank 202 and the stretchable film 204 together in the heated press 1006 to form the molded door skin 200. FIGS. 12A and 12B depict embodiments of pressing the blank 202 and the stretchable film 204 together in the heated press 1006 at step 1104 in accordance with aspects of the disclosure.

Step 1102 can include sizing, cutting, or aligning the stretchable film 204 on the outer surface of the blank 202. The stretchable film 204 can be positioned, sized, cut, or aligned on the outer surface of the blank 202 manually (rather than automatically), which thereby obviates the need for complicated automated machinery and improves the commercial viability of the method 1100. For example, manual positioning allows for the accommodation of blanks 202 in a variety of different sizes, which would be difficult or expensive to accommodate with automated machinery.

In some embodiments, the stretchable film 204 can be automatically positioned on the outer surface of the blank 202.

The stretchable film 204 can be positioned on the outer (i.e., visually observable) surface of the blank 202, and the blank 202 and stretchable film 204 can then together be placed into the press 1006. Alternatively, the blank 202 and stretchable film 204 can be sequentially placed in either order in the press 1006 and the positioning of the stretchable film 204 on the blank 202 can occur within the press 1006.

Positioning the stretchable film 204 on the outer surface of the blank 202 at step 1102 can occur prior to the pressing at step 1104.

As discussed above, the method 1100 can optionally include pretreating the blank 202 or the stretchable film 204 at step 1103. Pretreating the blank 202 or the stretchable film 204 can occur prior to pressing the blank 202 and the stretchable film 204 in the heated press 1006. In some embodiments, the pre-treatment can include a pre-press, and the blank 202 or the stretchable film 204 can be pressed in the pre-press before the pressing at the heated press 1006. Pre-pressing the blank 202 can decrease the resistance of the blank 202 in the heated press 1006 at step 1104, to reduce the time required for the pressing at step 1104 or to improve the quality of the resultant molded door skin 200.

In some embodiments, the pre-treatment can include a pre-heating step. For example, the blank 202 or the stretchable film 204 can be pre-heated using a pre-heater, such as a high frequency heated tunnel.

In some embodiments, the blank 202 and the stretchable film 204 may be pretreated together.

In some embodiments, the blank 202 may be treated prior to the positioning of the stretchable film 204 on the blank 202 at step 1102.

The pressing of the blank 202 and the stretchable film 204 at step 1104 can include any or all of the features of the pressing of step 903 of the method 900 discussed above. Further, as shown in FIGS. 12A and 12B, the blank 202 and the stretchable film 204 can be pressed in the press 1006 with either of the arrangements of the first and second dies 1018, 1020 discussed in references to FIGS. 10A and 10B above.

As a result of heat and pressure applied to the stretchable film 204 during step 1003 of the process 1100, a property of the stretchable film 204 can change such that the stretchable film 204 can fill cracks or voids formed in the outer surface of the blank 202.

In some embodiments, the changed property of the stretchable film 204 can be a malleability of the stretchable film 204 and the malleability can be increased at step 1104.

In some embodiments, the changed property of the stretchable film 204 can be a degree of fluidity and the stretchable film 204, which can become more fluid step 1104.

By filling the cracks or voids formed in the outer surface of the blank 202 with the stretchable film 204, an outer surface of the molded door skin 200 can be produced that is substantially or entirely crack and void free.

As discussed above, the heated press 1006 can be a single-opening or a multiple opening press. The single opening press can facilitate manual positioning of the stretchable film 204 on the outer surface of the blank 202, which can be difficult in multi-opening presses that typically require high-speed operation.

The foregoing description of the specific aspects the disclosure described with reference to the figures will so fully reveal the general nature of the disclosure that others can, by applying knowledge within the skill of the art, readily modify or adapt for various applications such specific aspects, without undue experimentation, without departing from the general concept of the present disclosure.

While various aspects of the present disclosure have been described above, they have been presented by way of example only, and not limitation. It should be apparent that adaptations and modifications are intended to be within the meaning and range of equivalents of the disclosed aspects, based on the teaching and guidance presented herein. It therefore will be apparent to one skilled in the art that various changes in form and detail can be made to the aspects disclosed herein without departing from the spirit and scope of the present disclosure. The elements of the aspects presented above are not necessarily mutually exclusive, but can be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary aspects but should be defined only in accordance with the following claims and their equivalents.

It is to be appreciated that the Detailed Description section, and not the Summary and

Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

What is claimed is:

1. A molded door skin comprising:
a first planar portion defining a first surface;
a second planar portion extending parallel to the first planar portion, the second planar portion defining a second surface recessed relative to the first surface by a predetermined distance; and
a third planar portion extending between the first and second planar portions, the third planar portion extending from the second planar portion at an angle in a range of 100 degrees and 120 degrees,
wherein the first, second, and third planar portions define an outer surface of the molded door skin that is substantially or entirely crack and void free.

2. The molded door skin of claim 1, wherein the predetermined distance is in a range of 6 mm to 9 mm.

3. The molded door skin of claim 1, wherein the second surface defines one panel of the molded door skin.

4. The molded door skin of claim 1, wherein the second surface defines three panels of the molded door skin.

5. The molded door skin of claim 1, wherein the second surface defines five panels of the molded door skin.

6. A molded door skin comprising:
a first planar portion defining a first surface;
a second planar portion extending parallel to the first planar portion, the second planar portion defining a second surface recessed relative to the first surface by a predetermined distance; and
a third planar portion extending between the first and second planar portions, the third planar portion extending from the second planar portion at an angle in a range of 100 degrees and 120 degrees,
wherein the first, second, and third planar portions define an outer surface of the molded door skin that is infused with a stretchable film such that the outer surface is substantially or entirely crack and void free.

7. The molded door skin of claim 6, wherein the predetermined distance is in a range of 6 mm to 9 mm.

8. The molded door skin of claim 6, wherein the second surface defines one panel of the molded door skin.

9. The molded door skin of claim 6, wherein the second surface defines three panels of the molded door skin.

10. The molded door skin of claim 6, wherein the second surface defines five panels of the molded door skin.

11. A method of forming a molded door skin, comprising:
providing a blank, the blank being an at least partially consolidated flat wood composite; and
pressing the blank in a heated press at a predetermined pressure for a predetermined amount of time to form the molded door skin, the molded door skin having:
a first planar portion defining a first surface;
a second planar portion extending parallel to the first planar portion, the second planar portion defining a second surface recessed relative to the first surface by a predetermined distance; and
a third planar portion extending between the first and second planar portions, the third planar portion extending from the second planar portion at an angle in a range of 100 degrees and 120 degrees,
wherein the first, second, and third planar portions define an outer surface of the molded door skin that is substantially or entirely crack and void free.

12. The molded door skin formed by the method of claim 11.

13. The method of forming the molded door skin of claim 11, wherein the predetermined distance is in a range of 6 mm to 9 mm.

14. A method of forming a molded door skin, comprising:
providing a blank, the blank being an at least partially consolidated flat wood composite;
positioning a stretchable film on an outer surface of the blank; and
pressing the blank and the stretchable film together in a heated press to form the molded door skin, the molded door skin having:
a first planar portion defining a first surface;
a second planar portion extending parallel to the first planar portion, the second planar portion defining a second surface recessed relative to the first surface by a predetermined distance; and
a third planar portion extending between the first and second planar portions, the third planar portion extending from the second planar portion at an angle in a range of 100 degrees and 120 degrees,
wherein cracks or voids formed in the outer surface of the blank during the pressing are filled with the stretchable film such that an outer surface of the molded door skin is substantially or entirely crack and void free.

15. The molded door skin formed by the method of claim 14.

16. The method of forming the molded door skin of claim 14, wherein the predetermined distance is in a range of 6 mm to 9 mm.

17. The method of forming the molded door skin of claim 14, wherein the blank is a partially consolidated blank.

18. The method of forming the molded door skin of claim 17, wherein the blank is solid such that the blank is configured to be moved or stored without altering a shape of the blank.

19. The method of forming the molded door skin of claim 14, wherein
a caliper of the blank is thicker than a caliper of the molded door skin, and
a density of the blank is less than a density of the molded door skin.

20. The method of forming the molded door skin of claim 14, wherein positioning the stretchable film on the outer surface of the blank includes at least one of sizing, cutting, and aligning the stretchable film.

21. The method of forming the molded door skin of claim 14, wherein the positioning of the stretchable film on the outer surface of the blank is performed manually.

22. The method of forming the molded door skin of claim 14, wherein the stretchable film comprises phenolic impregnated crepe paper.

23. The method of forming the molded door skin of claim 14, wherein the stretchable film is infused into the blank during formation of the molded door skin.

24. The method of forming the molded door skin of claim 14, wherein the stretchable film is pigmented.

25. The method of forming the molded door skin of claim 14, wherein the stretchable film is a primer configured improve paint adherence to the molded door skin.

26. The method of forming the molded door skin of claim 14, wherein the heated press is a single-opening press.

27. The method of forming the molded door skin of claim 14, further comprising pre-treating the blank prior to pressing the blank and the stretchable film together to form the molded door skin.

28. The method of forming the molded door skin of claim 14, wherein
the press includes first and second dies having complimentary opposing shapes,
the first die being a cavity mold that forms a back face of the molded door skin,
the second die being a core mold that forms a front face of the molded door skin, and
the cavity mold being disposed at the top of the press and the core mold being disposed at the bottom of the press.

29. The method of forming the molded door skin of claim 28, wherein the positioning includes arranging the stretchable film between the core mold and the blank.

30. The method of forming the molded door skin of claim 28, wherein the stretchable film is infused into the blank to form the outer surface at the front face of the molded door skin.
